(19) United States
(12) Patent Application Publication
(10) Pub. No.: US 2022/0175047 A1
(43) Pub. Date: Jun. 9, 2022

(54) METHOD OF ASSEMBLY AND APPARATUS FOR HEATING AEROSOLISABLE MATERIAL

(71) Applicant: Nicoventures Trading Limited, London (GB)

(72) Inventors: Chi Wai FUNG, Shenzhen, Guangdong (CN); Guang Yan WEI, Shenzhen, Guangdong (CN); Jonathon Neil BURGESS, London (GB); Daniel LOCHTMAN, London (GB); James SHERIDAN, London (GB); Conor John MCGRATH, London (GB); Jai-Ram TAANK, London (GB); Michael David THOMAS, London (GB); David William BUREAU, London (GB); Zexin WU, Shenzhen, Guangdong (CN)

(21) Appl. No.: 17/600,595

(22) PCT Filed: Apr. 4, 2019
(86) PCT No.: PCT/CN2019/081577

§ 371 Date: Sep. 30, 2021

(51) Int. Cl. A24F 40/70; A24F 40/40

(52) U.S. Cl. CPC A24F 40/70; A24F 40/20; A24F 40/40

(57) ABSTRACT

A method of assembling an apparatus (1) for heating aerosolisable material to volatilise at least one component of the aerosolisable material to form an aerosol for inhalation by a user, the apparatus having a first proximal end (3) and a second distal end (5), the method comprising the steps of providing a first chassis (19) for supporting a heating arrangement for receiving and heating aerosolisable material, the first chassis (19) or a component supported by the first chassis (19) comprising a first engagement element; providing a first sleeve (11b) to form at least a part of a casing of the apparatus, the first sleeve (11b) comprising a second engagement element; and inserting the first chassis (19) into a cavity of the first sleeve (11b) to cause automatic engagement of the first engagement element and the second engagement element during assembly of the apparatus (1).

### RELATED APPLICATION INFORMATION

The present application is a National Phase entry of PCT Application No. PCT/CN2019/081577, filed Apr. 4, 2019, which is hereby fully incorporated herein by reference.

### TECHNICAL FIELD

The present invention relates to methods of assembling an apparatus for heating aerosolisable material to volatilise at least one component of the aerosolisable material, and apparatus for heating aerosolisable material to volatilise at least one component of the aerosolisable material.

### BACKGROUND

Smoking articles, such as cigarettes, cigars and the like, burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present invention provides a method of assembling an apparatus for heating aerosolisable material to volatilise at least one component of the aerosolisable material to form an aerosol for inhalation by a user, the apparatus having a first proximal end and a second distal end. The method comprises: providing a first chassis for supporting a heating arrangement for receiving and heating aerosolisable material, the first chassis or a component supported by the first chassis comprising a first engagement element; providing a first sleeve to form at least a part of a casing of the apparatus, the first sleeve comprising a second engagement element; and inserting the first chassis into a cavity of the first sleeve to cause automatic engagement of the first engagement element and the second engagement element during assembly of the apparatus.

In an exemplary embodiment, the inserting causes engagement of the first chassis and the first sleeve or a component supported by the first chassis and the first sleeve via a first snap-fit arrangement comprising the first engagement element and the second engagement element.

In an exemplary embodiment, the inserting comprises inserting the first chassis towards an end stop of the first sleeve for blocking movement of the first chassis relative to the first sleeve by the end stop.

In an exemplary embodiment, the method comprises blocking movement of the first chassis relative to the first sleeve by the end stop. In an exemplary embodiment, the blocking movement comprises blocking movement of the first chassis relative to the first sleeve in a first direction opposite a second direction along which the first chassis is inserted into the cavity.

In an exemplary embodiment, the first snap-fit arrangement comprises the end stop.

In an exemplary embodiment, the first engagement element is a protrusion of the first chassis or the component support by the first chassis and the second engagement element is a receiving portion of the first sleeve. In an exemplary embodiment, the receiving portion comprises the end stop, and the engagement comprises inserting the protrusion into the receiving portion. In an exemplary embodiment, the protrusion is a clip.

In an exemplary embodiment, the first snap-fit arrangement exists at the second distal end.

In an exemplary embodiment, the step of inserting the first chassis into the cavity comprises abutting the first sleeve and the first chassis by the end stop at the second distal end of the apparatus.

In an exemplary embodiment, the first sleeve is for engaging with a second sleeve for combination to form a casing of the apparatus.

In an exemplary embodiment, the first proximal end is an end of the apparatus for receiving aerosolisable material and the second distal end is the end of the apparatus towards which the aerosolisable material is inserted.

In an exemplary embodiment, the second distal end is an end opposite an opening for inserting aerosolisable material into a heating chamber of the heating arrangement.

In an exemplary embodiment, the method comprises: providing a second chassis comprising a first zone for occupancy by a power source; and engaging the second chassis and the first chassis using a third engagement element of the first chassis and a fourth engagement element of the second chassis.

In an exemplary embodiment, the providing the second chassis comprises providing a second chassis comprising the first engagement element, and wherein the step of inserting the first chassis into the cavity of the first sleeve is after the step of engaging the second chassis and the first chassis.

In an exemplary embodiment, the engaging the second chassis and the first chassis comprises engaging using a second snap-fit arrangement comprising the third engagement element and the fourth engagement element. In an exemplary embodiment, the engaging the second chassis and the first chassis comprises inserting the second chassis into the cavity of the first sleeve before engaging the second chassis and the first chassis.

In an exemplary embodiment, the second chassis and first chassis are engaged at the second distal end of the apparatus.

In an exemplary embodiment, the second snap-fit arrangement exists at the second distal end.

In an exemplary embodiment, the snap-fit arrangement provides for localised flexing of at least one engageable part and momentarily distort the at least one engageable part.

In an exemplary embodiment, the step of inserting the first chassis into the cavity of the first sleeve is before the step of engaging the second chassis to the first chassis.

In an exemplary embodiment, the first chassis comprises a second zone for occupancy by at least one printed circuit board (PCB), and wherein the step of engaging the second chassis and the first chassis comprises surrounding, by the first sleeve, the second zone and only a portion of the first zone. In an exemplary embodiment, the second zone is for occupancy by a plurality of PCBs. In an exemplary embodiment, the PCBs are of substantially equal length.

In an exemplary embodiment, the step of surrounding, by the first sleeve, comprises surrounding, by the first sleeve, an entire length of the second zone.

In an exemplary embodiment, the method comprises providing a second sleeve of the casing; and engaging the second sleeve and the first sleeve using a fifth engagement element of the first sleeve and a sixth engagement element of the second sleeve.

In an exemplary embodiment, the engaging the second sleeve and the first sleeve comprises engaging the second sleeve and the first sleeve using a third snap-fit arrangement comprising the third engagement element and the fourth engagement element. In an exemplary embodiment, the first sleeve and second sleeve form a casing of the apparatus.

In an exemplary embodiment, the first to third snap-fit arrangements are different to each other. In an exemplary embodiment, the difference between the first to third snap-fit arrangements is a difference in geometry. In an exemplary embodiment, the difference between the first to third snap-fit arrangements is a difference in freedom of movement between engaged parts. In an exemplary embodiment, the difference between the first to third snap-fit arrangements is a difference in structure. In an exemplary embodiment, the difference between the first to third snap-fit arrangements is a difference in a number of engaging portions. In an exemplary embodiment, the third snap-fit arrangement may comprise three or more engaging portions. In an exemplary embodiment, the second snap-fit arrangement may comprise a plurality of engaging portions. In an exemplary embodiment, the first snap-fit arrangement may comprise a single engaging portion. In an exemplary embodiment, the third snap-fit arrangement may comprise at least one more engaging portion than the second snap-fit arrangement.

In an exemplary embodiment, the step of engaging the second sleeve and the first sleeve comprises surrounding, by each of the second sleeve and the first sleeve, at least a portion of the first zone. In an exemplary embodiment, the step of engaging the second sleeve and the first sleeve comprises surrounding, by each of the second sleeve and first sleeve, at least a portion of a power source within the power source compartment.

In an exemplary embodiment, the step of engaging the second sleeve and the first sleeve comprises restricting bi-directional movement of the first sleeve with respect to the first chassis, wherein the bi-directional movement is along an axis parallel to the longitudinal axis of a heating chamber. In an exemplary embodiment, the step of engaging the second sleeve and the first sleeve comprises progressive engagement. In an exemplary embodiment, the progressive engagement comprises intermittently engaging and disengaging the first sleeve and the second sleeve in a number of fixed steps. In an exemplary embodiment, the number of fixed steps of the intermittently engaging and disengaging corresponds to a number of engaging portions of the third snap-fit arrangement.

In an exemplary embodiment, the step of engaging the second sleeve and the first sleeve comprises inserting the engaged first and second chassis into the second sleeve before engaging the second sleeve and the first sleeve.

In an exemplary embodiment, the step of engaging the second sleeve and the first sleeve comprises causing a user-operated button to align with a hole in the second sleeve. In an exemplary embodiment, the step of engaging the second sleeve and the first sleeve comprises covering the user-operated button by the second sleeve until the user-operated button aligns with the hole in the second sleeve.

In an exemplary embodiment, the step of engaging the second sleeve and the first sleeve comprises surrounding, by the second sleeve, a portion of a heating chamber of the heating arrangement.

In an exemplary embodiment, the step of surrounding, by the second sleeve, comprises surrounding, by the second sleeve, only a portion of the heating chamber.

In an exemplary embodiment, the step of surrounding, by the second sleeve, comprises surrounding by the second sleeve, an expansion chamber of the heating arrangement.

In an exemplary embodiment, the step of surrounding, by the second sleeve, comprises surrounding a portion of the heating chamber by a thermal liner of the second sleeve, wherein the thermal liner has a different heat conductivity to the heat conductivity of the second sleeve. In an exemplary embodiment, comprising engaging the thermal liner and an interior of the second sleeve.

In an exemplary embodiment, the step of surrounding, by the second sleeve, comprises surrounding an expansion chamber of the heating arrangement.

In an exemplary embodiment, the second chassis comprises a pair of arms defining a third zone for occupancy by a support tube of the heating arrangement, wherein the step of engaging the first chassis and the second chassis comprises guiding the pair of arms around the support tube.

In an exemplary embodiment, the third snap-fit arrangement comprises cooperative engagement of a perimeter of the first sleeve and a perimeter of the second sleeve.

In an exemplary embodiment, the method comprises fastening the second sleeve to the second chassis using a fastener. In an exemplary embodiment, the step of fastening comprises engaging the fastener with a threaded portion of the second chassis. In an exemplary embodiment, the step of fastening comprises inserting the fastener first through the second sleeve and then the second chassis.

In an exemplary embodiment, the aerosolisable material comprises tobacco and/or is reconstituted and/or is in the form of a gel and/or comprises an amorphous solid.

A second aspect of the present invention provides an apparatus for heating aerosolisable material to volatilise at least one component of the aerosolisable material to form an aerosol for inhalation by a user, the apparatus having a first proximal end and a second distal end. the apparatus comprises: a first chassis for supporting a heating arrangement for receiving and heating aerosolisable material, the first chassis or a component supported by the first chassis comprising a first engagement element; and a first sleeve to form at least a part of the casing of the apparatus, the first sleeve comprising a second engagement element; wherein the first engagement element and second engagement element are arranged to automatically engage when the first chassis is inserted into a cavity of the first sleeve during assembly of the apparatus.

In an exemplary embodiment, the first sleeve comprises an end stop towards which the first chassis can be inserted such that movement of the first chassis relative to the first sleeve is configured to be blocked by the end stop.

In an exemplary embodiment, the end stop is provided at a distal end of the first sleeve. In an exemplary embodiment, the distal end of the first sleeve corresponds to the second distal end of the apparatus.

In an exemplary embodiment, the first proximal end is an end of the apparatus for receiving aerosolisable material and the second distal end is the end of the apparatus towards which the aerosolisable material is inserted.

In an exemplary embodiment, the second distal end is an end opposite an opening for inserting aerosolisable material into a heating chamber of the heating arrangement.

In an exemplary embodiment, the end stop is configured to block movement of the first chassis relative to the first sleeve in a first direction opposite a second direction along which the first chassis is inserted into the cavity.

In an exemplary embodiment, the first engagement element and the second engagement element form a first snap-fit arrangement for engagement of the first chassis and the first sleeve or the component supported by the first chassis and the first sleeve. In an exemplary embodiment, the first snap-fit arrangement comprises the end stop.

In an exemplary embodiment, the first engagement element is a protrusion of the first chassis or the component support by the first chassis and the second engagement element is a receiving portion of the first sleeve. In an exemplary embodiment, the receiving portion comprises the end stop. In an exemplary embodiment, the protrusion is a clip.

In an exemplary embodiment, the apparatus comprises a second chassis engageable with the first chassis using a third engagement element of the first chassis and a fourth engagement element of the second chassis. In an exemplary embodiment, the second chassis comprises the first engagement element. In an exemplary embodiment, the second chassis is engageable with the first chassis using a second snap-fit arrangement comprising the third engagement element and the fourth engagement element. In an exemplary embodiment, the snap-fit arrangement provides for localised flexing of at least one engageable part and momentarily distort the at least one engageable part.

In an exemplary embodiment, the apparatus comprises a second sleeve, such that when the second sleeve and first sleeve are engaged, each of the second sleeve and the first sleeve surrounds at least a portion of a first zone of the second chassis for occupancy by a power source.

In an exemplary embodiment, the heating arrangement comprises a heating chamber and each of the second sleeve and first sleeve surround a portion of the heating chamber.

In an exemplary embodiment, the second sleeve is engageable with the second chassis by a fastener, wherein the fastener is to first insert through the second sleeve and then the second chassis.

In an exemplary embodiment, the second sleeve comprises an opening for receiving aerosolisable material and a hole for alignment with a user-operated button.

In an exemplary embodiment, the aerosolisable material comprises tobacco and/or is reconstituted and/or is in the form of a gel and/or comprises an amorphous solid.

Further features and advantages of the invention will become apparent from the following description of preferred embodiments of the invention, given by way of example only, which is made with reference to the accompanying drawings.

### BRIEF DESCRIPTION OF THE DRAWINGS

Embodiments of the invention will now be described, by way of example only, with reference to the accompanying drawings, in which:

FIG. 1 shows a schematic perspective view of an example of an apparatus for heating aerosolisable material to volatilise at least one component of the aerosolisable material, wherein the apparatus is shown with a consumable article comprising aerosolisable material inserted.

FIG. 2 shows a schematic front view of the example apparatus of FIG. 1 with the consumable article inserted.

FIG. 3 shows a schematic right-side view of the example apparatus of FIG. 1 with the consumable article inserted.

FIG. 4 shows a schematic left-side view of the example apparatus of FIG. 1 with the consumable article inserted.

FIG. 5 shows a schematic front cross-sectional view of the example apparatus of FIG. 1 with the consumable article inserted through line A-A shown in FIG. 4.

FIG. 6 shows a schematic front cross-sectional view of the example apparatus of FIG. 1 without a consumable article inserted.

FIG. 7 shows an assembly procedure of parts of the example apparatus shown in FIG. 1.

FIG. 8 shows a schematic perspective view of a first assembly step comprising insertion of a first chassis and part of a heating arrangement of the example apparatus of FIG. 1 into the first sleeve of the example apparatus of FIG. 1 towards an end stop of the first sleeve.

FIG. 8a shows a schematic cross-sectional view of engaging parts of the first assembly step forming in a first snap-fit arrangement.

FIG. 9 shows a schematic perspective view of a second first assembly step comprising engaging the first chassis shown in FIG. 8 and the heating arrangement of the example apparatus of FIG. 1 to a second chassis of the example apparatus of FIG. 1.

FIG. 10 shows a first engageable portion of the second chassis shown in FIG. 9 for forming part of a second snap-fit arrangement.

FIG. 11 shows a second engageable portion of the first chassis shown in FIG. 9 for forming part of the second snap-fit arrangement and a clip of the first chassis for forming part of the first snap-fit arrangement.

FIG. 12 shows a schematic perspective view of a third assembly step comprising engaging the second sleeve of the example apparatus of FIG. 1 to the second chassis of the example apparatus of FIG. 1.

FIG. 13 shows a flow diagram showing an example of a method of assembling an apparatus for heating aerosolisable material to volatilise at least one component of the aerosolisable material.

### DETAILED DESCRIPTION

As used herein, the term “aerosolisable material” includes materials that provide volatilised components upon heating, typically in the form of vapour or an aerosol. “Aerosolisable material” may be a non-tobacco-containing material or a tobacco-containing material. “Aerosolisable material” may, for example, include one or more of tobacco per se, tobacco derivatives, expanded tobacco, reconstituted tobacco, tobacco extract, homogenised tobacco or tobacco substitutes. The aerosolisable material can be in the form of ground tobacco, cut rag tobacco, extruded tobacco, reconstituted tobacco, reconstituted aerosolisable material, liquid, gel, amorphous solid, gelled sheet, powder, or agglomerates, or the like. “Aerosolisable material” also may include other, non-tobacco, products, which, depending on the product, may or may not contain nicotine. “Aerosolisable material” may comprise one or more humectants, such as glycerol or propylene glycol. The term “aerosol generating material” may also be used herein interchangeably with the term “aerosolisable material”.

As noted above, the aerosolisable material may comprise an “amorphous solid”, which may alternatively be referred to as a “monolithic solid” (i.e. non-fibrous), or as a “dried gel”. The amorphous solid is a solid material that may retain some fluid, such as liquid, within it. In some cases, the aerosolisable material comprises from about 50 wt %, 60 wt % or 70 wt % of amorphous solid, to about 90 wt %, 95 wt % or 100 wt % of amorphous solid. In some cases, the aerosolisable material consists of amorphous solid.

As used herein, the term “sheet” denotes an element having a width and length substantially greater than a thickness thereof. The sheet may be a strip, for example.

As used herein, the term “heating material” or “heater material”, in some examples, refers to material that is heatable by penetration with a varying magnetic field, for example when the aerosolisable material is heated by an inductive heating arrangement.

Other forms of heating a heating material include resistive heating which involves electrically resistive heating elements that heat up when an electric current is applied to the electrically resistive heating element, thus transferring heat by conduction to the heating material.

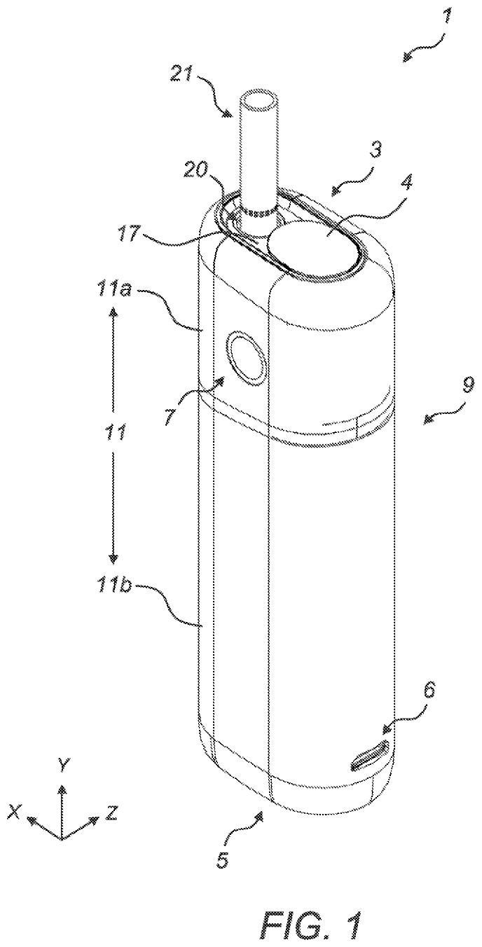

Referring to FIG. 1, there is shown a schematic perspective view of an apparatus 1 according to an embodiment of the invention. The apparatus 1 is for heating aerosolisable material to volatilise at least one component of the aerosolisable material to form an aerosol for inhalation by a user. In this embodiment, the aerosolisable material comprises tobacco, and the apparatus 1 is a tobacco heating product (also known in the art as a tobacco heating device or a heat-not-burn device). The apparatus 1 is a handheld device for inhalation of the aerosolisable material by the user of the handheld device.

The apparatus 1 comprises a first end 3 and a second end 5, opposite the first end 3. The first end 3 is sometimes referred to herein as the mouth end or proximal end of the apparatus 1. The second end 5 is sometimes referred to herein as the distal end of the apparatus 1. The apparatus 1 has an on/off button 7 to allow the apparatus 1, as a whole, to be switched on and off as desired by a user of the apparatus 1.

In broad outline, the apparatus 1 is configured to generate an aerosol to be inhaled by a user by heating an aerosol generating material. In use, a user inserts an article 21 into the apparatus 1 and activates the apparatus 1, e.g. using the button 7, to cause the apparatus 1 to begin heating the aerosol generating material. The user subsequently draws on a mouthpiece 21b of the article 21 near the first end 3 of the apparatus 1 to inhale an aerosol generated by the apparatus 1. As a user draws on the article 21, generated aerosol flows through the apparatus 1 along a flow path towards the proximal end 3 of the apparatus 1.

In examples a vapour is produced that then at least partly condenses to form an aerosol before exiting the apparatus 1 to be inhaled by the user.

In this respect, first it may be noted that, in general, a vapour is a substance in the gas phase at a temperature lower than its critical temperature, which means that for example the vapour can be condensed to a liquid by increasing its pressure without reducing the temperature. On the other hand, in general, an aerosol is a colloid of fine solid particles or liquid droplets, in air or another gas. A “colloid” is a substance in which microscopically dispersed insoluble particles are suspended throughout another substance.

For reasons of convenience, as used herein the term aerosol should be taken as meaning an aerosol, a vapour or a combination of an aerosol and vapour.

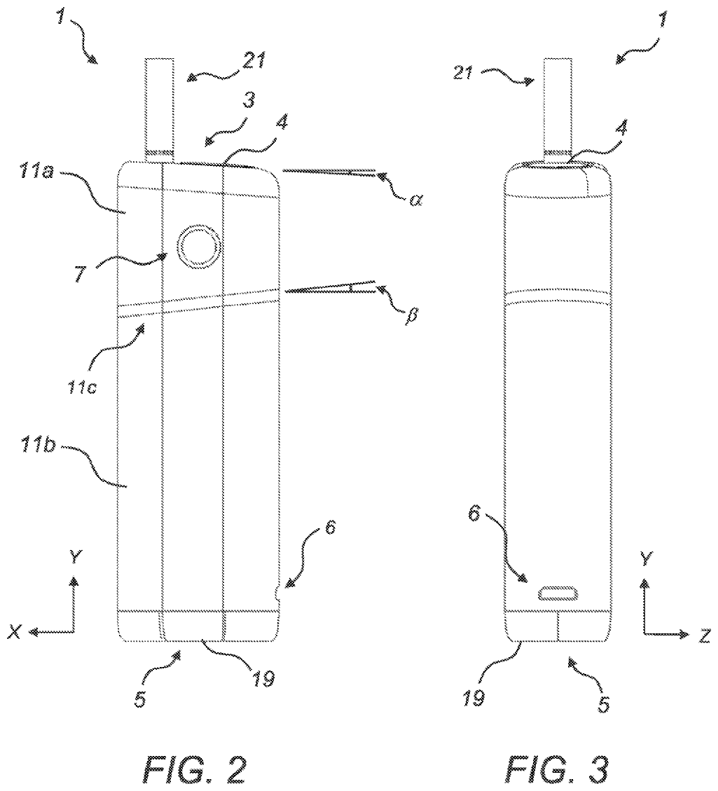

The apparatus 1 comprises a casing 9 for locating and protecting various internal components of the apparatus 1. The casing 9 is therefore an external housing for housing the internal components. In the embodiment shown, the casing 9 comprises a sleeve 11 that encompasses a perimeter of the apparatus 1, capped with a top panel 17, at the first end 3, which defines generally the ‘top’ of the apparatus 1 and a bottom panel 19, at the second end 5 (see FIGS. 2 to 5), which defines generally the ‘bottom’ of the apparatus 1.

The sleeve 11 comprises a second sleeve 11a and a first sleeve 11b. The second sleeve 11a is provided at a top portion of the apparatus 1, shown as an upper portion of the apparatus 1, and extends away from the first end 3. The first sleeve 11b is provided at a bottom portion of the apparatus 1, shown as a lower portion of the apparatus 1, and extends away from the second end 5. The second sleeve 11a and first sleeve 11b each encompass a perimeter of the apparatus 1. That is, the apparatus 1 comprises a longitudinal axis in a Y-axis direction, and the second sleeve 11a and the first sleeve 11b each surround the internal components in a direction radial to the longitudinal axis.

In this embodiment, the second sleeve 11a and a first sleeve 11b are removably engaged with each other. In this embodiment, the second sleeve 11a is engaged with the first sleeve 11b in a snap-fit arrangement comprising recesses.

In some embodiments, the top panel 17 and/or the bottom panel 19 may be removably fixed to the corresponding first and second sleeves 11b, 11a, respectively, to permit easy access to the interior of the apparatus 1. In some embodiments, the sleeve 11 may be “permanently” fixed to the top panel 17 and/or the bottom panel 19, for example to deter a user from accessing the interior of the apparatus 1. In one embodiment, the panels 17 and 19 are made of a plastics material, including for example glass-filled nylon formed by injection moulding, and the sleeve 11 is made of aluminium, though other materials and other manufacturing processes may be used.

The top panel 17 of the apparatus 1 has an opening 20 at the mouth end 3 of the apparatus 1 through which, in use, the consumable article 21 containing aerosolisable material is inserted into the apparatus 1 and removed from the apparatus 1 by a user. In this embodiment, the consumable article 21 acts as the mouthpiece for the user to place between lips of the user. In other embodiments, an external mouthpiece may be provided wherein at least one volatilised component of the aerosolisable material is drawn through the mouthpiece. When an external mouthpiece is used, the aerosolisable material is not provided in the external mouthpiece.

The opening 20 in this embodiment is opened and closed by a door 4. In the embodiment shown, the door 4 is movable between a closed position and an open position to allow for insertion of the consumable article 21 into the apparatus 1 when in the open position. The door 4 is configured to move bi-directionally along an X-axis direction.

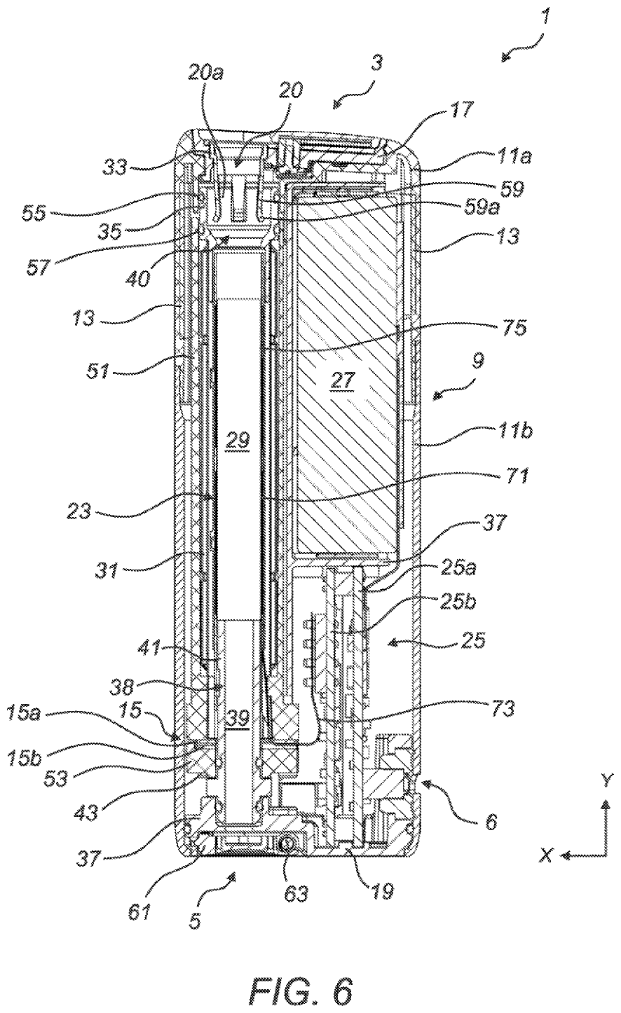

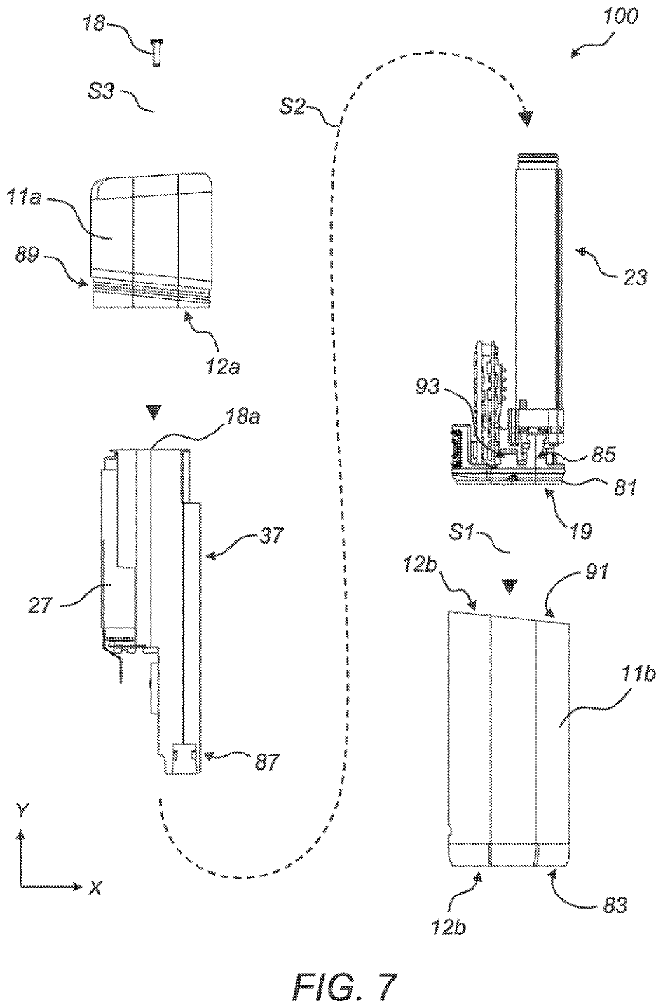

A connection port 6 is shown at the second end 5 of the apparatus 1. The connection port 6 is for connection to a cable and a power source 27 (shown in FIG. 6) for charging the power source 27 of the apparatus 1. The connection port 6 extends in a Z-axis direction from a front side of the apparatus 1 to a rear side of the apparatus 1. As shown in FIG. 3, the connection port 6 is accessible on a right-side of the apparatus 1 at the second end 5 of the apparatus 1. Advantageously, the apparatus 1 may stand on the second end 5 whilst charging or to provide a data connection through the connection port 6. In the embodiment shown, the connection port 6 is a USB socket.

Referring to FIG. 2, the second sleeve 11a comprises a surface at the first end 3 of the apparatus 1 that is tapered. The tapered surface comprises a first angle a with respect to a surface of the first sleeve 11b at the second end 5. In this embodiment, the surface of the first sleeve 11b at the second end 5 is substantially parallel to the X-axis direction. Therefore, as shown, the consumable article 21 is insertable through the opening 20 (shown in FIG. 1) at a proximal portion of the first end 3. Where the second sleeve 11a and first sleeve 11b meet at a join 11c, a second angle β with respect to the X-axis direction is formed. The second angle β is shown to be greater than the first angle α.

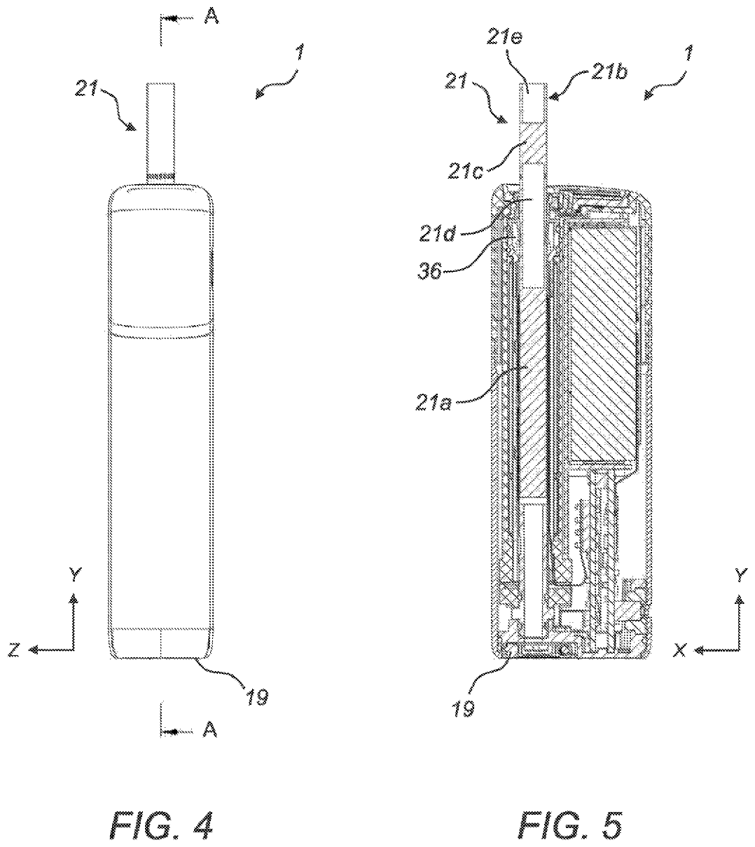

FIG. 3 and FIG. 4 respectively show a right-side and left-side of the apparatus 1. Here, the consumable article 21 is shown in a laterally central location. This is because the opening 20 through which the consumable article 21 is inserted is positioned at a mid-way point of the apparatus along the and Z-axis direction and off-centre in the X-axis direction.

FIG. 5 and FIG. 6 show schematic front cross-sectional views of the apparatus 1 with the consumable article inserted and withdrawn, respectively through line A-A of the apparatus 1, as shown in FIG. 4.

As shown in FIG. 6, the casing 9 has located or fixed therein a heater arrangement 23, control circuitry 25 and the power source 27. In this embodiment, the control circuitry 25 is part of an electronics compartment and comprises two printed circuit boards (PCBs) 25a, 25b. In this embodiment, the control circuitry 25 and the power source 27 are laterally adjacent to the heater arrangement 23 (that is, adjacent when viewed from an end), with the control circuitry 25 being located below the power source 27. Advantageously, this provides allows the apparatus 1 to be compact in a lateral direction, corresponding to the X-axis direction.

The control circuitry 25 in this embodiment includes a controller, such as a microprocessor arrangement, configured and arranged to control the heating of the aerosolisable material in the consumable article 21, as discussed further below.

The power source 27 in this embodiment is a rechargeable battery. In other embodiments, a non-rechargeable battery, a capacitor, a battery-capacitor hybrid, or a connection to a mains electricity supply may be used. Examples of suitable batteries include for example a lithium-ion battery, a nickel battery (such as a nickel-cadmium battery), an alkaline battery and/or the like. The battery 27 is electrically coupled to the heater arrangement 23 to supply electrical power when required and under control of the control circuitry 25 to heat the aerosolisable material in the consumable (as discussed, to volatilise the aerosolisable material without causing the aerosolisable material to burn).

An advantage of locating the power source 27 laterally adjacent to the heater arrangement 23 is that a physically large power source 27 may be used without causing the apparatus 1, as a whole, to be unduly lengthy. As will be understood, in general, a physically large power source 27 has a higher capacity (that is, the total electrical energy that can be supplied, often measured in Amp-hours or the like) and thus the battery life for the apparatus 1 can be longer.

In one embodiment, the heater arrangement 23 is generally in the form of a hollow cylindrical tube, having a hollow interior heating chamber 29 into which the consumable article 21 comprising the aerosolisable material is inserted for heating, in use. Broadly speaking, the heating chamber 29 is a heating zone for receiving the consumable article 21. Different arrangements for the heater arrangement 23 are possible. In some embodiments, the heater arrangement 23 may comprise a single heating element or may be formed of plural heating elements aligned along the longitudinal axis of the heater arrangement 23. The or each heating element may be annular or tubular, or at least part-annular or part-tubular around its circumference. In an embodiment, the or each heating element may be a thin-film heater. In another embodiment, the or each heating element may be made of a ceramics material. Examples of suitable ceramics materials include alumina and aluminium nitride and silicon nitride ceramics, which may be laminated and sintered. Other heater arrangements are possible, including for example inductive heating, infrared heater elements, which heat by emitting infrared radiation, or resistive heating elements formed by for example a resistive electrical winding.

In this embodiment, the heater arrangement 23 is supported by a stainless steel support tube 75 and comprises a heater 71. In one embodiment, the heater 71 may comprise a substrate in which at least one electrically conductive element is formed. The substrate may be in the form of a sheet and may comprise for example a plastics layer. In a preferred embodiment the layer is a polyimide layer. The electrically conductive element/s may be printed or otherwise deposited in the substrate layer. The electrically conductive element/s may be encapsulated within or coated with the substrate.

The support tube 75 is a heating element that transfers heat to the consumable article 21. The support tube 75 comprises therefore heating material. In this embodiment, the heater material is stainless steel. In other embodiments, other metallic materials may be used as the heating material. For example, the heating material may comprise a metal or a metal alloy. The heating material may comprise one or more materials selected from the group consisting of: aluminium, gold, iron, nickel, cobalt, conductive carbon, graphite, steel, plain-carbon steel, mild steel, ferritic stainless steel, molybdenum, copper, and bronze.

The heater arrangement 23 is dimensioned so that substantially the whole of the aerosolisable material when the consumable article 21 is inserted in the apparatus 1 so that substantially the whole of the aerosolisable material is heated in use.

In some embodiments, the or each heating element may be arranged so that selected zones of the aerosolisable material can be independently heated, for example in turn (over time) or together (simultaneously) as desired.

The heater arrangement 23 in this embodiment is surrounded along at least part of its length by a vacuum region 31. The vacuum region 31 helps to reduce heat passing from the heater arrangement 23 to the exterior of the apparatus 1. This helps to keep down the power requirements for the heater arrangement 23 as it reduces heat losses generally. The vacuum region 31 also helps to keep the exterior of the apparatus 1 cool during operation of the heater arrangement 23. In some embodiments, the vacuum region 31 may be surrounded by a double-walled sleeve wherein the region between the two walls of the sleeve has been evacuated to provide a low-pressure region so as to minimise heat transfer by conduction and/or convection. In other embodiments, another insulating arrangement may be used, for example using heat insulating materials, including for example a suitable foam-type material, in addition to or instead of a vacuum region.

The casing 9, sometimes referred to as a housing, may further comprise various internal support structures 37 (best seen in FIG. 6) for supporting all internal components, as well as the heater arrangement 23.

The apparatus 1 further comprises a collar 33 which extends around and projects from the opening 20 into the interior of the housing 9 and an expansion element 35 which is located between the collar 33 and one end of the vacuum region 31. The expansion element 35 is a funnel that forms an expansion chamber 40 at the mouth end 3 of the apparatus 1. The collar 33 is a retainer for retaining the consumable article 21 (as is best shown in FIG. 5). In this embodiment, the retainer is reversibly removable from the apparatus 1.

One end of the expansion element 35 connects to and is supported by the second sleeve 11a and the other end of the expansion element 35 connects to and is support by one end of a cassette 51. A first sealing element 55, shown as an o-ring, is interposed between the expansion element 35 and the second sleeve 11a, and a second sealing element 57, also shown as an o-ring, is interposed between the expansion element 35 and the cassette 51. Each o-ring is made of silicone, however, other elastomeric materials may be used to provide the seal. The first and second sealing elements 55, 57 prevent the transmission of gas into surrounding components of the apparatus 1. Sealing elements are also provided at the distal end to prevent fluid ingress and egress at the distal end.

As best seen in FIG. 6, the collar 33, the expansion element 35 and the vacuum region 31/heater arrangement 23 are arranged co-axially, so that, as best seen in FIG. 5, when the consumable article 21 is inserted in the apparatus 1, the consumable article 21 extends through the collar 33 and the expansion element 35 into the heating chamber 29.

As mentioned above, in this embodiment, the heater arrangement 23 is generally in the form of a hollow cylindrical tube. The heating chamber 29 formed by this tube is in fluid communication with the opening 20 at the mouth end 3 of the apparatus 1 via the expansion chamber 40.

In this embodiment, the expansion element 35 comprises a tubular body that has a first open end adjacent the opening 20 and a second open end adjacent the heating chamber 29. The tubular body comprises a first section that extends from the first open end to approximately half away along the tubular body and a second section that extends from approximately half away along the tubular body to the second open end. The first section comprises a flared portion that widens away from the second section. The first section therefore has an internal diameter that tapers outwardly towards the opening first open end. The second section has a substantially constant internal diameter.

As best seen in FIG. 6, in this embodiment, the expansion element 35 is located in the housing 9 between the collar 33 and the vacuum region 31/heater arrangement 23. More specifically, at the second open end, the expansion element 35 is interposed between an end portion of the support tube 75 of the heater arrangement 23 and an inside of the vacuum region 31 so that the second open end of the expansion element 35 engages with the support tube 75 and the inside of the vacuum region 31. At the first open end, the expansion element 35 receives the collar 33 so that legs 59 of the collar 33 project into the expansion chamber 40. Therefore, an inner diameter of the first section of the expansion element 35 is greater than an external diameter of the legs when the consumable article 21 is received in the apparatus 1 (see FIG. 5) and when no consumable article 21 is present.

As is best appreciated from FIG. 5, the inner diameter of the first section of the expansion element 35 is larger than the external diameter of the consumable article 21. There is therefore an air gap 36 between the expansion element 35 and the consumable article 21 when the consumable article 21 is inserted in the apparatus 1 over at least part of the length of the expansion element 35. The air gap 36 is around the entire circumference of the consumable article 21 in that region.

As best seen in FIG. 6, the collar 33 comprises a plurality of legs 59. In this embodiment there are four legs 59, where only three are visible in the view of FIG. 6. However, in other embodiments there may be more or fewer than four legs 59. The legs 59 are arranged circumferentially equally spaced around an inner surface of the collar 33 and exist in the expansion chamber 40 when the apparatus 1 is assembled. In this embodiment, when installed in the apparatus 1, the legs 59 are circumferentially equally spaced around the periphery of the opening 20. In one embodiment, there are four legs 59, in other embodiments there may be more or fewer than four legs 59. Each of the legs 59 extend in the Y-axis direction and parallel to the longitudinal axis of the expansion chamber 40 and project into the opening 20. The legs 59 also extend radially at a tip 59a of the leg 59 in a direction towards the expansion element 35 such that the tips 59a are angled away from each other. The tip 59a of each leg 59 provides for improved passage of the consumable article 21 so as to avoid damage to the consumable article 21 when inserting and/or removing the consumable article 21 from the apparatus 1. Together, the legs 59 provide a gripping section that grips the consumable article 21 in order to correctly position and retain the portion of the consumable article 21 that is within the expansion chamber 40 when the consumable article 21 is within the apparatus 1. Between them, the legs 59 gently compress or pinch the consumable article 21 in the region or regions of the consumable article that are contacted by the legs 59.

The legs 59 may be comprised of a resilient material (or be resilient in some other way) so that they deform slightly (for example compress) to better grip the consumable article 21 when the consumable article 21 is inserted in the apparatus 1 but then regain their original shape when the consumable article 21 is removed from the apparatus 1 since the legs 59 are biased to a rest position shown in FIG. 6. Therefore, the legs 59 are reversibly movable from a first position, which is the rest position, to a second position, which is a deformed position shown in FIG. 5, whereby the consumable article 21 is gripped. In this embodiment, the legs 59 are formed integrally with a main body of the collar 33. However, in some embodiments, the legs 59 may be separate components that are attached to the body of the collar 33. The inner diameter of the space formed between the legs 59 in the first, rest position, may be, for example, between 4.8 mm and 5 mm, and preferably 4.9 mm. The legs 59 take up space within the opening 20 such that the open span of the opening 20 at the locations of the legs 59 is less than the open span of the opening 20 at the locations without the legs 59.

The expansion element 35 may be formed of for example a plastics material, including for example polyether ether ketone (PEEK). PEEK has a relatively high melting point compared to most other thermoplastics, and is highly resistant to thermal degradation.

Referring to FIG. 6, in this embodiment, the heating chamber 29 communicates with a region 38 of reduced internal diameter towards the distal end 5. This region 38 defines a clean-out chamber 39 formed by a clean-out tube 41. The clean-out tube 41 is a hollow tube that provides an end stop for the consumable article 21 passed through the opening at the mouth end 3 (see FIG. 5). The clean-out tube 41 is arranged to support and locate the heater arrangement 23.

The apparatus 1 may further comprise a door 61 at the distal end 5 of the apparatus 1 that opens and closes an opening in the bottom panel 19 to provide access to the heating chamber 29 so that the heating chamber 29 can be cleaned. The door 61 pivots about a hinge 63. This access through the door 61 particularly enables the user to clean within the heater arrangement 23 and the heating chamber 29 at the distal end 5. When the door 61 is open, a straight through-bore is provided through the whole apparatus 1 between the opening 20 at the mouth end 3 and an opening at one end of the clean-out chamber at the distal end 5 of the apparatus 1. The user is therefore easily able to clean through substantially the whole of the interior of the hollow heating chamber 29. For this, the user can access the heating chamber 29 via either end of the apparatus 1 at choice. The user may use one or more various cleaning devices for this purpose, including for example a classic pipe cleaner or a brush or the like.

As shown in FIG. 6, the top panel 17 generally forms the first end 3 of the housing 9 of the apparatus 1. The top panel 17 supports the collar 33 which defines an insertion point in the form of the opening 20 through which the consumable article 21 is removably inserted into the apparatus 1 in use.

The collar 33 extends around and projects from the opening 20 into the interior of the housing 9. In this embodiment, the collar 33 is a distinct element from the top panel 17, and is attached to the top panel 17 through an attachment, such as a bayonet locking mechanism. In other embodiments, an adhesive or screws may be used to couple the collar 33 to the top panel 17. In other embodiments, the collar 33 may be integral with the top panel 17 of the housing 9 so the collar 33 and the top panel 17 form a single piece.

As best appreciated from FIGS. 5 and 6, open spaces defined by adjacent pairs of legs 59 of the collar 33 and the consumable article 21 form ventilation paths 20a around the exterior of the consumable article 21. These ventilation paths 20a, allow hot vapours that have escaped from the consumable article 21 to exit the apparatus 1 and allow cooling air to flow into the apparatus 1 around the consumable 21. In this embodiment, four ventilation paths are located around the periphery of the consumable article 21, which provide ventilation for the apparatus 1. In other embodiments, more or fewer of such ventilation paths 20a may be provided.

Referring again particularly to FIG. 5, in this embodiment, the consumable article 21 is in the form of a cylindrical rod which has or contains aerosolisable material 21a at a rear end in a section of the consumable article 21 that is within the heater arrangement 23 when the consumable article 21 is inserted in the apparatus 1. A front end of the consumable article 21 extends from the apparatus 1 and acts as the mouthpiece 21b which is an assembly that includes one or more of a filter for filtering aerosol and/or a cooling element 21c for cooling aerosol. The filter/cooling element 21c is spaced from the aerosolisable material 21a by a space 21d and is also spaced from a tip of mouthpiece assembly 21b by a further space 21e. The consumable article 21 is circumferentially wrapped in an outer layer (not shown). In this embodiment, the outer layer of the consumable article 21 is permeable to allow some heated volatilised components from the aerosolisable material 21a to escape the consumable article 21.

In operation, the heater arrangement 23 will heat the consumable article 21 to volatilise at least one component of the aerosolisable material 21a.

The primary flow path for the heated volatilised components from the aerosolisable material 21a is axially through the consumable article 21, through the space 21d, the filter/cooling element 21c and the further space 21e before entering a user's mouth through the open end of the mouthpiece assembly 21b. However, some of the volatilised components may escape from the consumable article 21 through its permeable outer wrapper and into the space 36 surrounding the consumable article 21 in the expansion chamber 40.

It would be undesirable for the volatilised components that flow from the consumable article 21 into the expansion chamber 40 to be inhaled by the user, because these components would not pass through the filter/cooling element 21c and thus would be unfiltered and not cooled.

Advantageously, the volume of air surrounding the consumable article 21 in the expansion chamber 40 causes at least some of the volatilised components that escape the consumable article 21 through its outer layer to cool and condense on the interior wall of the expansion chamber 40 preventing those volatilised components from being possibly inhaled by a user.

This cooling effect may be assisted by cool air that is able to enter from outside the apparatus 1 into the space 36 surrounding the consumable article 21 in the expansion chamber 40 via the ventilation paths 20a, which allows fluid to flow into and out of the apparatus. A first ventilation path is defined between a pair of the plurality of neighbouring legs 59 of the collar 33 to provide ventilation around the outside of the consumable article 21 at the insertion point. A second ventilation path is provided between a second pair of neighbouring legs 59 for at least one heated volatilised component to flow from the consumable article 21 at a second location. Therefore, ventilation is provided around the outside of the consumable article 21 at the insertion point by the first and second ventilation paths. Furthermore, heated volatilised components that escape the consumable article 21 through its outer wrapper do not condense on the internal wall of the expansion chamber 40 and are able to flow safely out of the apparatus 1 via the ventilation paths 20a without being inhaled by a user. The expansion chamber 40 and the ventilation both aid in reducing the temperature and the content of water vapour composition released in heated volatilised components from the aerosolisable material.

The apparatus 1 is fitted with a thermal liner 13 towards the first end 3 of the apparatus 1. As shown in FIG. 6, the liner 13 is engaged with the second sleeve 11a. The thermal liner 13 is a heat diffuser that helps to manage heat distribution and helps to protect the second sleeve 11a from thermal stress by distributing internal heat generated by use of the apparatus 1 over a larger area. The thermal liner 13 is made from a metallic material such as aluminium in order to be lightweight and sufficiently spread heat around the proximal end 3. This helps to avoid localised hot spots and increases the longevity of the second sleeve 11a. The liner 13 distributes heat by conduction. The liner 13 is not configured to insulate heat or reflect heat by radiation.

As shown in FIG. 6, the support tube 75 is externally wrapped by a heater 71. In this example, the heater 71 is a thin-film heater comprising polyimide and electrically conductive elements. The heater 71 may comprise a plurality of heating regions that are independently controlled and/or simultaneously controlled. In this example, the heater 71 is formed as a single heater. However, in other embodiments, the heater 71 may be formed of a plurality of heaters aligned along the longitudinal axis of the heating chamber 29. In some embodiments, a plurality of temperature sensors may be used to detect the temperature of the heater 71 and/or support tube. The support tube 75 in this embodiment is made from stainless steel to conduct heat from the heater 71 towards the consumable article 21 when the consumable article 21 is inserted in a heating zone (the heating zone is defined by the thermal conduction region of the support tube 75). In other embodiments, the support tube 75 may be made from a different material, as long as the support tube 75 is thermally conductive. Other heating elements 75 may be used in other embodiments. For example, the heating element may be a susceptor that is heatable by induction. In this embodiment, the support tube 75 acts as an elongate support for supporting, in use, the article 21 comprising aerosolisable material.

In this embodiment, the heater 71 is located externally of the support tube 75. However, in other embodiments, the heater 71 may be located internally of the support tube 75. The heater 71 in this embodiment comprises a portion that passes outside of the support tube 75 and is referred to herein as a heater tail 73. The heater tail 73 extends beyond the heating chamber 29 and is configured for electrical connection to the control circuitry 25. In the embodiment shown, the heater tail 73 physically connects to one PCB 25a. An electrical current may be provided by the power source 27 to the heater 71 via the control circuitry 25 and the heater tail 73.

As a connection between the heating chamber 29 and the control circuitry 25 is required, it can be difficult to prevent airflow (or the flow of any other fluids) between the heating chamber 29 and the electronics compartment. In this embodiment, a gasket 15 is used to prevent such fluid flow, as shown in FIG. 6. The gasket 15 comprises a first seal 15a and a second seal 15b. The gasket 15 surrounds the heater tail 73 and is clamped together by a base 53 and the cassette 51. In the embodiment shown, four fastening members 43 are used to provide the enough force to clamp the base 53 and cassette 51 together and seal off access to and from the chamber 29 at this point. The fastening members 43 are screws that are tightened to a predetermined torque. In other embodiments, different fastening members 43 may be used such as bolts.

Referring to FIG. 7, an assembly procedure 100 is shown. The assembly procedure 100 is for assembling parts of the apparatus 1 shown in FIG. 1.

In this embodiment, the assembly procedure 100 comprises three steps S1-S3. Each of the three steps S1-S3 are shown in FIG. 7 by a dashed arrow. The order of the three steps S1-S3 does not necessarily equate to the step number because the steps are interchangeable and can be performed in any order. For example, at least one of the three steps S1-S3 can be performed as a first step or as a last step of the assembly procedure 100. This provides an assembly process which is flexible.

When the three assembly steps S1-S3 are provided in sequence (step S1 first, step S2 second, S3 third), the assembly process is convenient because each part or group of parts are is/are brought together with an adjacent part or group of parts in the same direction. The direction may be a downward direction, for example in the Y-axis direction (corresponding to a direction parallel to the longitudinal axis of the apparatus 1), and the bringing together of the various components may be towards a surface on which the first sleeve 11b stands or is configured to stand (for example, the bottom end 5 of the apparatus 1).

In a first assembly step S1, a first chassis 19 is brought towards a first sleeve 11b. In this embodiment, the first chassis 19 comprises the bottom panel 19 of the apparatus 1. The insertion direction of the first chassis 19 into the first sleeve 11b corresponds to the Y-axis direction. The first chassis 19 is shown engaged with and supporting the heating arrangement 23 and the control circuity 25. As previously discussed, aerosolisable material is received by the heating arrangement 23 by inserting the aerosolisable material in a longitudinal direction parallel to the longitudinal axis of the apparatus 1 and the longitudinal axis of the elongate heating zone 29.

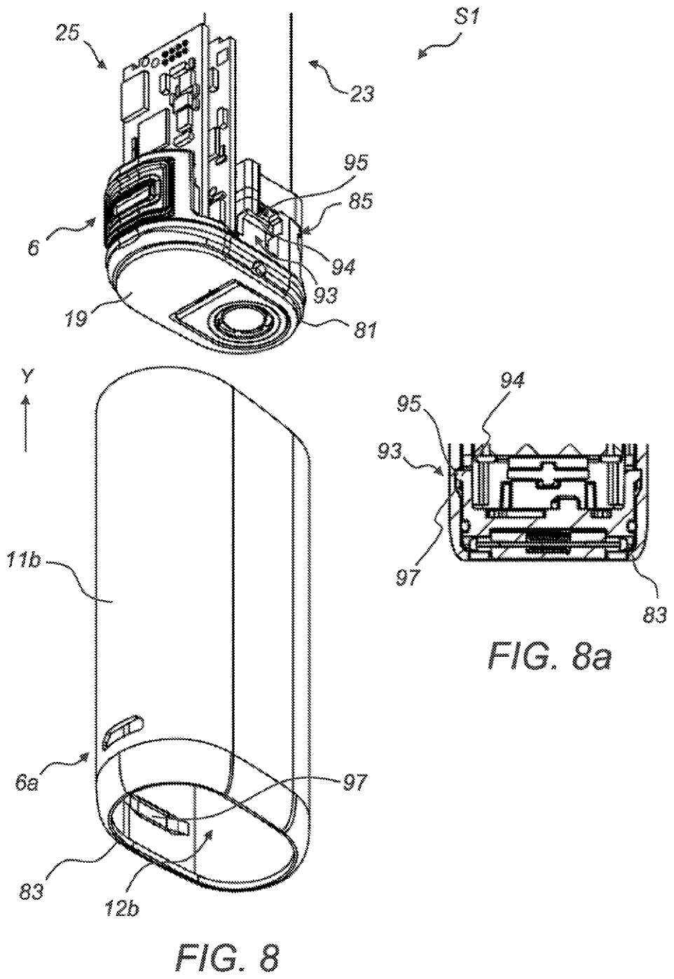

In the first assembly step S1, as also shown in FIG. 8, the engaged first chassis 19 and heating arrangement 23 are inserted into a cavity 12b of the first sleeve 11b.

In this embodiment, the control circuitry 25, comprising the two PCBs 25a, 25b (shown in FIG. 6), are also engaged with the first chassis 19.

Following insertion of the first chassis 19 and the heating arrangement 23 into the cavity 12b, relative movement of the first chassis 19 and first sleeve is inhibited by a first end stop 97 (see FIG. 8) shown as a receiving portion 97. The receiving portion 97 is configured to receive a clip 93 of the first chassis 19. The clip 93 may be referred to as a tab because the clip 93 is a protrusion. The clip 93 is configured to deflect under load in order to mate with the receiving portion 97. In this embodiment, the clip 93 is shown as a cantilever protrusion. The clip 93 therefore comprises a tip at a distal end away from a body of the first chassis 19, and a base at a proximal end closest to the body of the first chassis 19. The tip is configured to deflect or flex about the base in order to engage and disengage. Although in this embodiment, first engagement element, as shown by the clip 93, is part of the first chassis 19, in other embodiments, the first engagement element may be comprised by a component that is supported by the first chassis 19. The second chassis 37, for example, is a component that is supported by the first chassis 19, when the second chassis 37 is engaged with the first chassis 19.

The clip 93 and receiving portion 97 are each examples of an engagement element that latch together to interlock. The clip 93 may be said to be a first engagement element and the receiving portion 97 may be said to be a second engagement element. In this embodiment, a degree of movement is provided between the clip 93 and receiving portion 97. This is because precise location control in the first assembly step S1 is not required, unlike the second and third assembly steps S2, S3. In other embodiments, little or no freedom of movement may be provided between the clip 93 and receiving portion 97 because precise location control may be used.

The receiving portion 97 comprises an edge which abuts a protrusion 95 of the clip 93 to block the clip 93 and inhibits relative movement of the first chassis 19 and first sleeve 11b at least in a first direction, for example, the direction opposite to the direction of insertion of the first chassis 19 into the cavity 12b.

The clip 93 is shown inside the receiving portion 97 in FIG. 8a. The protrusion 95 of the clip 93 is automatically received in the receiving portion 97 when the first chassis 19 is inserted into the cavity 12b of the first sleeve 11b. The clip 93 is caused to deflect inwardly by the first sleeve 11b until the clip 93 is received in the receiving portion 97. Once received in the receiving portion 97, the clip 93 is not structurally stressed or deflected from a resting position.

An abutment portion 81 of the first chassis 19 is configured to abut a second end stop 83 of the first sleeve 11b. The second end stop 83 acts to restrict relative movement between the first sleeve 11b and the first chassis 19 in a second direction, for example, the direction of insertion of the first chassis 19 into the cavity 12b. In this embodiment, the second end stop 83 inhibits relative movement between the first sleeve 11b and the first chassis 19 in a direction opposite the direction of relative movement inhibited by the first end stop 97. Accordingly, the abutment between the abutment portion 81 and the second end stop 83 may prevent further insertion of the first chassis 19 through the cavity 12b of the first sleeve 11b. The abutment portion 81 is shown as a ledge which extends around the perimeter of the first chassis 19.

In some embodiments, the abutment portion 81 may be a protrusion or a plurality of protrusions as long as the abutment portion 81 is able to abut with the second end stop 83. The second end stop 83 is therefore configured to block (restrict) relative movement between the first chassis 19 and the first sleeve 11b in the insertion direction. That is, the second end stop 83 inhibits insertion of the first chassis 19 in a direction along the Y-axis direction. In contrast, the first end stop 97 is configured to block (restrict) relative movement between the first chassis 19 and the first sleeve 11b in a withdrawal direction opposite to the insertion direction. The blocking direction of the second end stop 83 may be one direction along the Y-axis direction such that the first chassis 19 and first sleeve 11b are free to move relative each other at this stage in the direction opposite the insertion direction.

In the embodiment shown, the second end stop 83 is provided at a distal end of the first sleeve 11b, whereas the first end stop 97 is provided close to the distal end of the first sleeve 11b and not at the distal end. However, in other embodiments, the second end stop 83 may be provided away from the distal end of the first sleeve 11b.

As shown in FIG. 7 and FIG. 8, the abutment portion 81 of the first chassis 19 and the second end stop 83 of the first sleeve 11b are both located at a distal end, towards the bottom of the apparatus 1 (see FIGS. 5 and 6). In this embodiment, the abutment portion 81 of the first chassis 19 comprises an end space for receiving the second end stop 83 of the first sleeve 11b. In some embodiments, the abutment portion 81 of the first chassis 19 may comprise a plurality of protrusions forming a space between adjacent protrusions, wherein the space is for receiving a protrusion of the second end stop 83 of the first sleeve 11b. In this embodiment, the second end stop 83 of the first sleeve 11b comprises an end of the first sleeve 11b, which, as shown in FIG. 6, is at the distal end of the first sleeve 11b. The second end stop 83 is shown in this embodiment as an inwardly turned portion of a main body of the first sleeve 11b, rather than a protrusion of the main body of the first sleeve 11b. In some embodiment, the second end stop 83 of the first sleeve 11b may comprise a protrusion, which may be a single protrusion. In other embodiments, the second end stop 83 may comprise a plurality of protrusions.

When the abutment portion 81 of the first chassis 19 is configured to abut the second end stop 83 in the first assembly step S1, an aperture 6a provides access to the electrical connection port 6. Otherwise, the main body of the first sleeve 11b covers the first chassis 19 and at least part of the heating arrangement 23.

In this embodiment, the first chassis 19 is engaged with the first sleeve 11b by a first snap-fit arrangement in the first assembly step S1 of the assembly procedure 100. The first snap-fit arrangement comprises the clip 93 and the receiving portion 97. As the first chassis 19 moves towards the distal end of the first sleeve 11b the protrusion 95 of the clip 93 automatically enters the receiving portion 97 of the first sleeve 11b. When the clip 93 enters the cavity 12b, the clip 93 is configured to automatically deflect inwardly and then automatically deflect outwardly when arriving at the receiving portion 97.

As further shown in FIG. 8a, the protrusion 95 comprises a ramped portion 94. The ramped portion 94 provides ease of engaging of the first snap-fit arrangement and the positive fitment of the first chassis 19 to the first sleeve 11b. The protrusion 95 also comprises a blocking portion to prevent withdrawal of the first chassis 19 from the first sleeve 11b in a direction opposite the direction of insertion. The blocking portion abuts the receiving portion 97. The only way to remove the first chassis 19 from the first sleeve 11b once engaged by the first snap-fit arrangement is to reversibly deflect the clip 93 and remove the protrusion 95 from the receiving portion 97.

In the embodiment shown, the first snap-fit arrangement comprises two clips 93 and two receiving portions 97 are shown. The two clips 93 are arranged on opposing sides of the chassis 19 and the two receiving portions 97 are arranged on opposing sides of the first sleeve 11b. In other embodiments, the first snap-fit arrangement may comprise a single clip 93 to engage with a corresponding single receiving portion 97.

The first assembly step S1 is convenient because no lining up of the engaging parts of the first snap-fit arrangement is required because a shape of the cavity 12b of the first sleeve 11b effectively feeds the first chassis 19 along the first sleeve 11b. The act of insertion therefore leads to automatic engagement of engagement elements. A process of pushing the two parts together, in this instance, the first chassis 19 and the first sleeve 11b, leads to automatic interlocking of the first chassis 19 and the first sleeve 11b.

Referring to FIGS. 7 and 9-11, a second assembly step S2 of the assembly procedure 100 is shown. The second assembly step S2 comprises the bringing together of the first chassis 19 and a second chassis 37.

In this embodiment, the second chassis 37 is a support structure for the power source 27. The second chassis 37 comprises a first zone where the power source 27 is positioned. That is, the first zone is for occupancy by the power source 27. The second chassis 37 comprises a first engageable portion 87. The first chassis 19 comprises a second engageable portion 85. Together, the first engageable portion 87 and the second engageable portion 85 form a second snap-fit arrangement. The first engageable portion 87 and second engageable portion 85 are each examples of an engagement element. The second engageable portion 85 may be said to be a third engagement element and the first engageable portion 87 be said to be a fourth engagement element.

In this embodiment, a lesser degree of movement is provided between the first engageable portion 87 and second engageable portion 85 than a degree of movement between the clip 93 and the receiving portion 97. This is because more precise location control is required in the second assembly step S2, unlike the first assembly step S1. In other embodiments, some freedom of movement may be provided between the first engageable portion 87 and second engageable portion 85.

Once the first chassis 19 is fully inserted in the cavity 12b of the first sleeve 11b, such that the abutment portion 81 abuts the second end stop 83, the first sleeve 11b is configured to surround only a portion of the first zone. Furthermore, a second zone for occupancy by the PCBs 25a, 25b is surrounded by the first sleeve 11b, when the second chassis 37 is engaged with the first chassis 19 in the second and first assembly steps S1, S2.

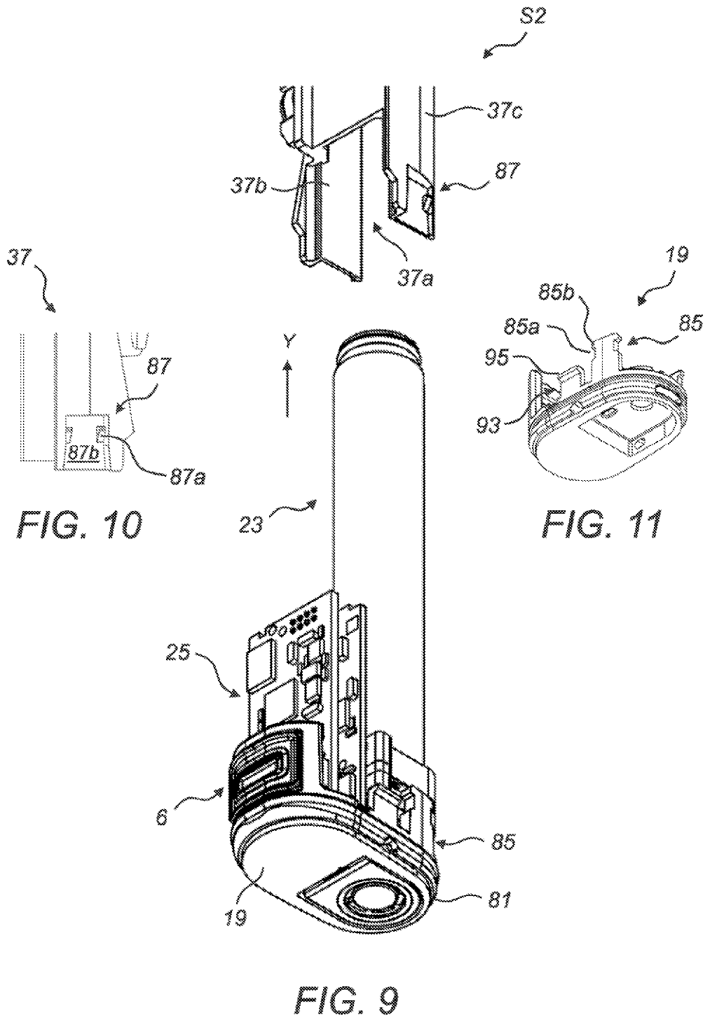

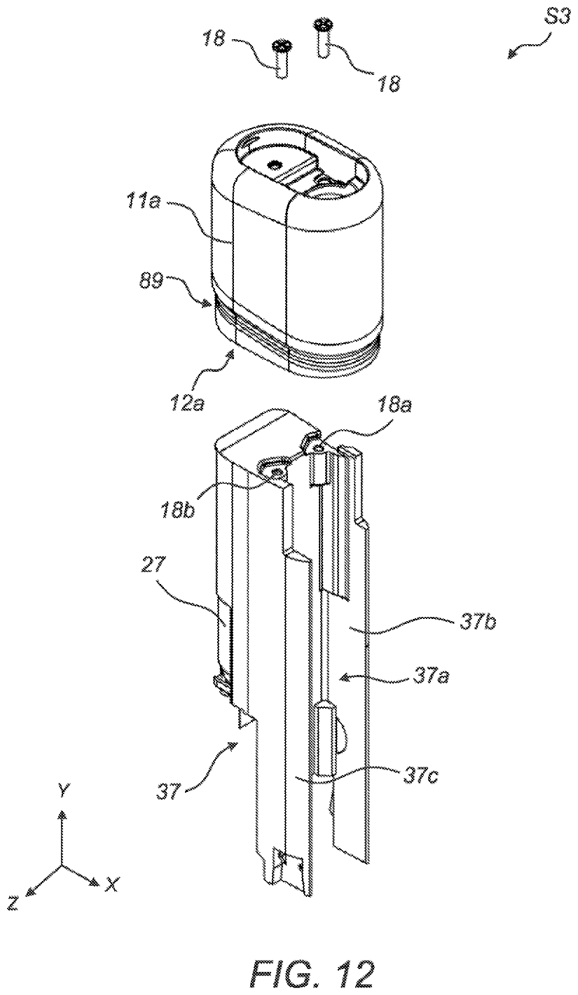

As shown in FIGS. 9 and 12, the second chassis 37 comprises a first arm 37b and a second arm 37c defining a cavity 37a therebetween. The cavity 37a of the second chassis 37 is for receiving the heating arrangement 23 engaged with the first chassis 19. As further shown in FIG. 10, each of the first and second arms 37a, 37b comprise the first engageable portion 87.

As shown in FIG. 10, the first engageable portion 87 comprises two first protrusions 87a which are spaced apart from each other by a first recess 87b.

As shown in FIG. 11, the second engageable portion 85 is a clip for insertion into and engagement with the first engageable portion 87. The second engageable portion 85 comprises two second recesses 85a to receive the two first protrusions 87a of the first engageable portion 87. Once received, the two first protrusions 87a of the first engageable portion 87 abut against a wall of the second engageable portion 85 defining two second protrusions 85b to retain the first and second engageable portions 87, 85 together and engage the first chassis 19 and the second chassis 37.

As shown in FIG. 10, for example, the two first protrusions 87a of the first engageable portion 87 comprise a ramped portion to allow the two second protrusions 85b of the second engageable portion 85 to slide along the two first protrusions 87a before entering the first recess 87b. The ramped portion tapers from a tip of each of the first protrusions 87a towards the first recess 87b.

Once engaged, the two first protrusions 87a are held within the respective second recesses 85a of the second engageable portion 85 and the two second protrusions 85b of the second engageable portion 85 are held within the first recess 87b of the first engageable portion 87.

The snap-fit arrangement of the first engageable portion 87 and the second engageable portion 85 therefore provide greater resistance to separation of the engagement. Although local deformation is required to engage and separate the first engageable portion 87 and the second engageable portion 85, the reversible deformation (deflection) is encouraged by the ramped portion to provide ease of insertion and positive fitment of the first chassis 19 and second chassis 37.

Although the temporary flexing of the first engageable portion 87 and the second engageable portion 85 occurs, in this embodiment the flexing movement is reversible and the first engageable portion 87 and the second engageable portion 85 return to a state of rest when the first chassis 19 and the second chassis 37 are engaged. In the state of rest, no deformation force is exerted between the first engageable portion 87 and the second engageable portion 85.

In this embodiment, the second snap-fit arrangement provides cooperative engagement between the first engageable portion 87 and the second engageable portion 85 when the second chassis 87 and first chassis 19 are engaged. That is, the first engageable portion 87 and the second engageable portion 85 are interlocked once engaged so as to prevent (inhibit) relative movement between the second chassis 37 and the first chassis 19. For example, the two second protrusions 85b fit precisely within the recess 87b to prevent such relative movement. In other embodiments, cooperatively engagement may not be required, for example when friction is used to hold a state of engagement.

The engaging of parts using a snap-fit arrangement allows engaged parts to be pushed together and combined in a simple manner. In some embodiments, the engagement of one engagement element with another engagement element may inhibit movement but not entirely restrain the two parts. That is, in some snap-fit arrangements, some play between the parts may exist.

Referring to FIGS. 7 and 12, a third assembly step S3 of the assembly procedure 100 is shown. The third assembly step S3 comprises bringing together the second sleeve 11a with the second chassis 37.

The second sleeve 11a comprises a cavity 12a to receive the second chassis 37 and heating arrangement 23. Once brought together, the second sleeve 11a can be engaged to the second chassis 37 using a fastener 18. Once engaged, the user-operated button 7 is caused to align with a hole in the second sleeve 11a. As shown in FIG. 2, the hole corresponds to the outer concentric circle and the inner concentric circle corresponds to the user-operated button 7. In the embodiment shown, two fasteners 18 are shown. In other embodiments, a single fastener 18 may be used as long as the second sleeve 11a is held securely to the second chassis 37. The use of two fasteners 18 helps to distribute forces across a larger area than with one fastener 18 to provide stability in the assembly procedure 100. In other examples, three or more fasteners 18 may be used. To accommodate the fasteners 18, threaded portions 18 are provided in a main body of the second chassis 27.

When the first chassis 19 is engaged with the second chassis 37, the fasteners 18 allow the second sleeve 11a to be engaged with the second chassis 37 so that the second sleeve 11a, second chassis 37 and first chassis 19 can be engaged as a unit to the first sleeve 11b. The fasteners 18 also help to improve the ease of assembly by holding a relative position of the second sleeve 11a to the engaged second chassis 37 and first chassis 19 when engaging the second sleeve 11a and the first sleeve 11b in the third assembly step S3.

The second sleeve 11a is engaged with the first sleeve 11b under a third snap-fit arrangement in the third assembly step S3. The third snap-fit arrangement comprises a first arrangement 89 of protrusions and spaces of the second sleeve 11a. The protrusions and spaces of the first arrangement 89 are angled to the X-axis direction. In other embodiments, the protrusions and spaces of the first arrangement 89 may be arranged in the X-axis direction. The first sleeve comprises a second arrangement 91 comprising a protrusion. In other embodiments, the second arrangement 91 may comprise protrusions and spaces and may be substantially the same as the first arrangement 89 for respective engagement.

As the second sleeve 11a is brought towards the first sleeve 11b the protrusion of the second arrangement 91 is intermittently passed between adjacent spaces formed between the protrusions of the first arrangement 89. This provides feedback to an assembler and provides a stepped engagement procedure. When fully inserted, the first arrangement 89 is within the cavity 12b of the first sleeve 11b and is concealed by the first sleeve 11b.

The first arrangement 89 and second arrangement 91 are each examples of an engagement element. The second arrangement 91 may be said to be a fifth engagement element and the first arrangement 89 be said to be a sixth engagement element. In this embodiment, little or no freedom of movement is provided between the first arrangement 89 and second arrangement 91 when engaged. This is because the first sleeve 11b and the second sleeve 11a are required to be precisely engaged as a single unit. Such location control is more important than in the first assembly step S1, for example.

As shown in FIG. 6, when apparatus 1 is assembled, such that the second sleeve 11a and first sleeve 11b are engaged, each of the second sleeve 11a and the first sleeve 11b is configured to surround at least a portion of the first zone within which the power source 27 is positioned.

Advantageously, the apparatus 1 is assembled in a quick and convenient manner. The use of snap-fit arrangements leads to an automatic engaging of parts to help speed up the assembly process.

Although a snap-fit arrangement is described, in some embodiments, the first and second engagement elements, the third and fourth engagement elements, and/or the fifth and sixth engagement elements form a mechanical latch mechanism that engages and/or disengages under pressure. That is, respective engagement elements of the mechanical mechanism can be pressed together to engage. The process of pressing together the respective engagement elements leads to the temporary flexing of at least one of the engagement elements before the engagement elements are caused to automatically interlock. The activation of the interlocking is therefore caused by the insertion of one of the engagement elements into another one of the engagement elements.

The first to sixth engagement elements described herein engage so as to interlock. The interlocking causes the two separate components or groups of components to become coupled. Although there may be some freedom of movement between the coupled components or groups of components the engagement of the engagement elements inhibits separation. That is, disengagement only occurs when at least one engagement element flexes (deflects) in a reversible manner.

Although the first chassis 19 comprises the first engagement element, the first engagement element may be comprised by any of the internal components that are supported by the first chassis 19. For example, the first engagement element may be comprised by at least one of the heating arrangement 23, the control circuity 25, the second chassis 37, and the power source 27. In some embodiments, when the first engagement element is comprised by the second chassis 37 and/or the power source 27, the first assembly step S1 occurs after the second assembly step S2. However, in other embodiments, the second assembly step S2 of engaging the first chassis 19 to the second chassis 37 may be performed before an assembly step of engaging the first sleeve 11b with the second chassis 37 and/or the power source 27. This is because automatic engagement occurs between the second chassis 37 and/or the power source 27 and the first sleeve 11b during assembly of the apparatus rather than between the first chassis 19 and the first sleeve 11b.

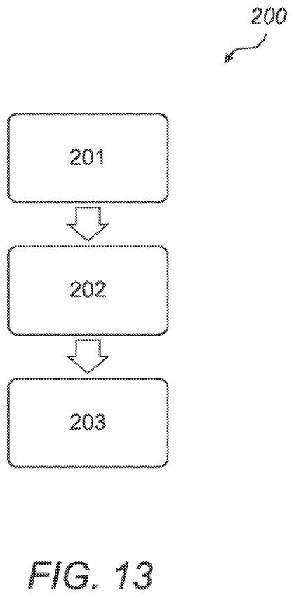

FIG. 13 shows a flow diagram showing an example of a method 200 of assembling an apparatus for heating aerosolisable material to volatilise at least one component of the aerosolisable material. The method may additionally comprise any of the features as previously described alone or in combination.

The method 200 comprises providing a first chassis 201 for supporting a heating arrangement for receiving and heating aerosolisable material, the first chassis comprising a first engagement element. The method 200 further comprises providing a first sleeve 202 to form at least a part of a casing of the apparatus, the first sleeve comprising a second engagement element. Once the first chassis and first sleeve are provided, the method comprises inserting the first chassis 203 into a cavity of the first sleeve to cause automatic engagement of the first engagement element and the second engagement element during assembly of the apparatus.

In some embodiments, the aerosolisable material comprises tobacco. However, in other embodiments, the aerosolisable material may consist of tobacco, may consist substantially entirely of tobacco, may comprise tobacco and aerosolisable material other than tobacco, may comprise aerosolisable material other than tobacco, or may be free from tobacco. In some embodiments, the aerosolisable material may comprise a vapour or aerosol forming agent or a humectant, such as glycerol, propylene glycol, triacetin, or diethylene glycol.

In some embodiments, the aerosolisable material is non-liquid aerosolisable material, and the apparatus is for heating non-liquid aerosolisable material to volatilise at least one component of the aerosolisable material.

Once all, or substantially all, of the volatilisable component(s) of the aerosolisable material in the consumable article 21 has/have been spent, the user may remove the article 21 from the apparatus 1 and dispose of the article 21. The user may subsequently re-use the apparatus 1 with another of the articles 21. However, in other respective embodiments, the article may be non-consumable, and the apparatus and the article may be disposed of together once the volatilisable component(s) of the aerosolisable material has/have been spent.

In embodiments described herein the consumable article 21 comprises a mouthpiece assembly 21b. However, it will be appreciated that in other embodiments an example apparatus as described herein may comprise a mouthpiece. For example, the apparatus 1 may comprise a mouthpiece which is integral with the apparatus, or in other embodiments the apparatus may comprise a mouthpiece which is detachably attached to the apparatus 1. In an example, the apparatus 1 may be configured to receive aerosolisable material to be heated. The aerosolisable material may be contained in a consumable article not comprising a mouthpiece portion. A user may draw on the mouthpiece of the apparatus 1 to inhale aerosol generated by the apparatus by heating the aerosolisable material.

In some embodiments, the article 21 is sold, supplied or otherwise provided separately from the apparatus 1 with which the article 21 is usable. However, in some embodiments, the apparatus 1 and one or more of the articles 21 may be provided together as a system, such as a kit or an assembly, possibly with additional components, such as cleaning utensils.

In order to address various issues and advance the art, the entirety of this disclosure shows by way of illustration and example various embodiments in which the claimed invention may be practised and which provide for superior heating elements for use with apparatus for heating aerosolisable material, methods of forming a heating element for use with apparatus for heating aerosolisable material to volatilise at least one component of the aerosolisable material, and systems comprising apparatus for heating aerosolisable material to volatilise at least one component of the aerosolisable material and a heating element heatable by such apparatus. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. A method of assembling an apparatus for heating aerosolisable material to volatilise at least one component of the aerosolisable material to form an aerosol for inhalation by a user, the apparatus having a first proximal end and a second distal end, the method comprising the steps of:
providing a first chassis for supporting a heating arrangement for receiving and heating aerosolisable material, the first chassis or a component supported by the first chassis comprising a first engagement element;
providing a first sleeve to form at least a part of a casing of the apparatus, the first sleeve comprising a second engagement element; and
inserting the first chassis into a cavity of the first sleeve to cause automatic engagement of the first engagement element and the second engagement element during assembly of the apparatus.

2. The method of claim 1, wherein the inserting causes engagement of the first chassis and the first sleeve or the component supported by the first chassis and the first sleeve via a first snap-fit arrangement comprising the first engagement element and the second engagement element.

3. The method of claim 1, wherein the inserting comprises inserting the first chassis towards an end stop of the first sleeve for blocking movement of the first chassis relative to the first sleeve by the end stop.

4. The method of claim 1, wherein the first engagement element is a protrusion of the first chassis or the component support by the first chassis and the second engagement element is a receiving portion of the first sleeve.

5. The method of claim 1, comprising:
providing a second chassis comprising a first zone for occupancy by a power source; and
engaging the second chassis and the first chassis using a third engagement element of the first chassis and a fourth engagement element of the second chassis.

6. The method of claim 5, wherein the providing the second chassis comprises providing a second chassis comprising the first engagement element, and wherein the step of inserting the first chassis into the cavity of the first sleeve is after the step of engaging the second chassis and the first chassis.

7. The method of claim 5, wherein the step of inserting the first chassis into the cavity of the first sleeve is before the step of engaging the second chassis and the first chassis.

8. The method of claim 5, wherein the first chassis comprises a second zone for occupancy by at least one printed circuit board (PCB), and wherein the step of engaging the second chassis and the first chassis comprises surrounding, by the first sleeve, the second zone and only a portion of the first zone.

9. The method of claim 8, wherein the step of surrounding, by the first sleeve, comprises surrounding, by the first sleeve, an entire length of the second zone.

10. The method of claim 1, comprising:
providing a second sleeve of the casing; and
engaging the second sleeve and the first sleeve using a fifth engagement element of the first sleeve and a sixth engagement element of the second sleeve.

11. The method of claim 10, wherein the step of engaging the second sleeve and the first sleeve comprises surrounding, by each of the second sleeve and the first sleeve, at least a portion of the first zone.

12. The method of claim 10, wherein the step of engaging the second sleeve and the first sleeve comprises inserting the engaged first and second chassis into the second sleeve before engaging the second sleeve and the first sleeve.

13. The method of claim 10, wherein the step of engaging the second sleeve and the first sleeve comprises causing a user-operated button to align with a hole in the second sleeve.

14. The method of claim 13, wherein the step of engaging the second sleeve and the first sleeve comprises covering the user-operated button by the second sleeve until the user-operated button aligns with the hole in the second sleeve.

15. The method of claim 10, wherein the step of engaging the second sleeve and the first sleeve comprises surrounding, by the second sleeve, a portion of a heating chamber of the heating arrangement.

16. The method of claim 15, wherein the surrounding, by the second sleeve, comprises surrounding, by the second sleeve, only a portion of the heating chamber.

17. An apparatus for heating aerosolisable material to volatilise at least one component of the aerosolisable material to form an aerosol for inhalation by a user, the apparatus having a first proximal end and a second distal end, the apparatus comprising:
a first chassis for supporting a heating arrangement for receiving and heating aerosolisable material, the first chassis or a component supported by the first chassis comprising a first engagement element; and
a first sleeve to form at least a part of the casing of the apparatus, the first sleeve comprising a second engagement element;
wherein the first engagement element and second engagement element are arranged to automatically engage when the first chassis is inserted into a cavity of the first sleeve during assembly of the apparatus.

18. The apparatus of claim 17, wherein the first engagement element and the second engagement element form a first snap-fit arrangement for engagement of the first chassis and the first sleeve or the component supported by the first chassis and the first sleeve.

19. The apparatus of claim 18, wherein the first engagement element is a protrusion of the first chassis or the component support by the first chassis and the second engagement element is a receiving portion of the first sleeve.

20. The apparatus of claim 17, comprising a second chassis engageable with the first chassis using a third engagement element of the first chassis and a fourth engagement element of the second chassis.

21. The apparatus of claim 20, wherein the second chassis comprises the first engagement element.

22. The apparatus of claim 20, wherein the second chassis is engageable with the first chassis using a second snap-fit arrangement comprising the third engagement element and the fourth engagement element.

23. The apparatus of claim 17, comprising a second sleeve, such that when the second sleeve and first sleeve are engaged, each of the second sleeve and the first sleeve surrounds at least a portion of a first zone of the second chassis for occupancy by a power source.
